(19) United States
(12) Patent Application Publication
(10) Pub. No.: US 2014/0327618 A1
(43) Pub. Date: Nov. 6, 2014

(54) COMPUTER INPUT DEVICE

(71) Applicant: Peigen Jiang, Sammamish, WA (US)

(72) Inventor: Peigen Jiang, Sammamish, WA (US)

(21) Appl. No.: 13/875,791

(22) Filed: May 2, 2013

(51) Int. Cl. G06F 3/02

(52) U.S. Cl. CPC G06F 3/0227
USPC 345/160

(57) ABSTRACT

A computer input method is disclosed which comprises detecting key press by a keyboard having a plurality of permanent keys for entering commands and characters into the computer, a surface area of the plurality of permanent keys having a designated region, detecting touch on the surface area of the plurality of permanent keys, entering into a cursor positioning mode when only one first touch on the surface of the plurality of permanent keys being detected while the key touched by the first touch not being pressed and the first touch being located outside the designated region, entering into a scroll-and-zoom mode when only one second touch on the surface of the plurality of permanent keys being detected while the key touched by the second touch not being pressed and the second touch being located inside the designated region and in a move, and entering into a keyboard mode when two or more simultaneously touched locations on the surface area of the plurality of permanent keys being detected.

### BACKGROUND

The present invention relates generally to human input devices for computing systems, and, more particularly, to a computer keyboard and mouse combo device.

One of the most popular ways to position a cursor on a computer display is to use a mouse, which functions by detecting two dimensional motions relative to its supporting surface. Physically, a mouse comprises an object held under one of a user's hands, with one or more buttons. Clicking or hovering (stopping movement while the cursor is within the bounds of an area) can select files, programs or actions from a list of names, or (in graphical interfaces) through small images called “icons” and other elements. For example, a text file might be represented by a picture of a paper notebook, and clicking while the cursor hovers over this icon may cause a text editing program to open the file in a window.

When mice have more than one button, software may assign different functions to each button. Often, a primary (leftmost in a right-handed configuration) button on the mouse will select items (primary click), and a secondary (rightmost in a right-handed) button will bring up a menu of alternative actions applicable to that item (secondary click).

Conventional mouse or touchpad also supports a scrolling operation, in which texts or images slide either vertically or horizontally across a computer display. The scrolling does not change the layout of the texts or images, but moves the user's view across what is apparently a larger image that is not wholly seen. A conventional mouse may be equipped with a small wheel to allow such scrolling operation. A conventional touchpad allows such scrolling operation by detecting finger swipes on the surface of the touchpad.

Another important display operation is zooming in which a document or image is enlarged when being zoomed in or shrunk when being zoomed out. Such zooming operation is achieved through either mouse or touchpad in conventional computing devices.

While conventional mice or touchpad can be highly accurate and capable pointing devices for computers, being a separate device they have some short-comings, such as every time when a computer user wants to move a cursor, he or she has to move his or her hand away from the keyboard and to the mouse, and move the mouse as a physical object. It is not only less efficient but also may cause injury to the hand over an extended period of time of use.

On the other hand, a conventional keyboard can only detect a pressing of any key thereof, but cannot detect mere touches on the keys. Here, the “touch” refers to a surface of the keyboard being contacted by an object regardless if the key is pressed or not. If the conventional keyboard is a tactile one, the key pressing results from the key being depressed. If the conventional keyboard is a surface one, such as Touch Cover for Microsoft Surface, the key pressing results from a force being applied on the key. As long as the key remains depressed in tactile keyboard or forced upon in surface keyboard, the key is pressed.

As such, what is desired is a computer input device that can perform both keyboard and mouse functions without relying on moving any additional object other than a user's fingers.

### SUMMARY

A computer input method is disclosed which comprises detecting key press by a keyboard having a plurality of permanent keys for entering commands and characters into the computer, a surface area of the plurality of permanent keys having a designated region, detecting touch on the surface area of the plurality of permanent keys, entering into a cursor positioning mode when only one first touch on the surface of the plurality of permanent keys being detected while the key touched by the first touch not being pressed and the first touch being located outside the designated region, entering into a scroll-and-zoom mode when only one second touch on the surface of the plurality of permanent keys being detected while the key touched by the second touch not being pressed and the second touch being located inside the designated region and in a move, and entering into a keyboard mode when two or more simultaneously touched locations on the surface area of the plurality of permanent keys being detected.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a perspective view of a laptop computer with a keyboard.

FIG. 2 illustrates an infrared-light touch sensing system positioned to detect touch on the keyboard surface according to an embodiment of the present invention.

FIG. 3 is a layout diagram of keyboard keys according to the embodiment of the present invention.

FIG. 4 is a block diagram of a computing system with a keyboard-mouse combo device according to the embodiment of present invention.

FIG. 5 is a flow chart diagram illustrating steps of certain operations of the keyboard-mouse combo device according to the embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to a computer input device utilizing a touch sensing device and a conventional keyboard to provide both keyboard and mouse functions for the computer. The conventional keyboard generally refers to those tactile keyboards with permanent keys. On-screen keyboards are not conventional keyboard at least for the reason that the keys are not permanent. A preferred embodiment of the present invention will be described hereinafter with reference to the attached drawings.

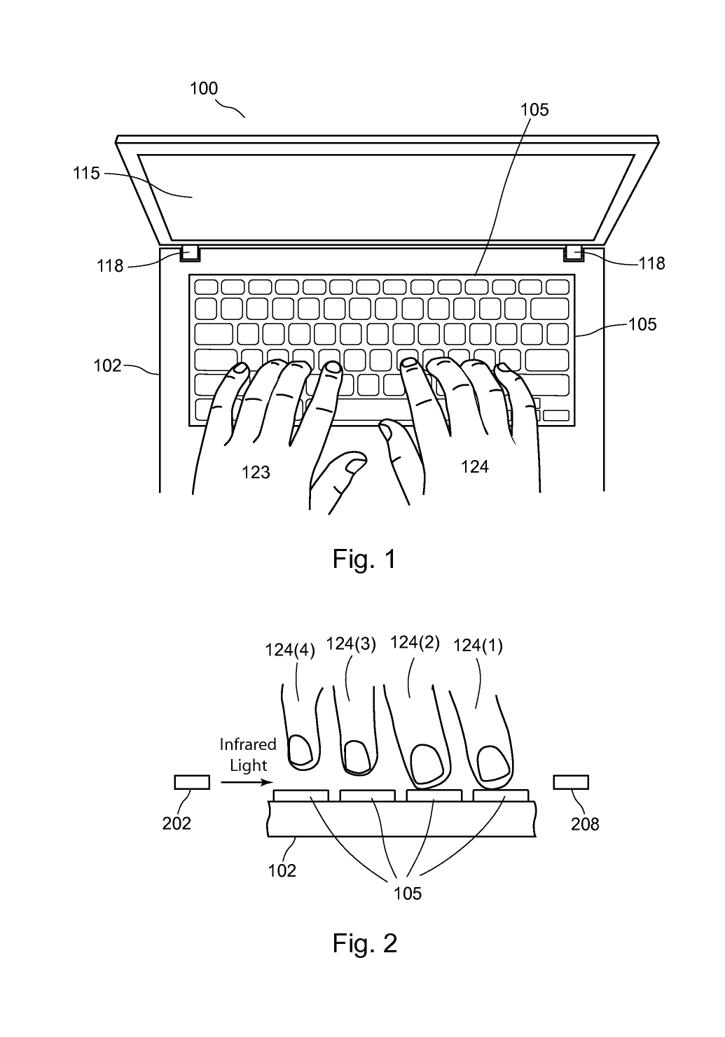

FIG. 1 is a perspective view of a laptop computer 100 with a conventional keyboard 105 for entering text, etc. The laptop computer 100 has a base unit 102 containing the keyboard 105, and a display panel 115 which is hinged to the base unit 102 by hinges 118. A skilled computer user can generally type on the keyboard 105 with both hands 123 and 124.

FIG. 2 illustrates an infrared-light touch sensing system positioned to detect touches on the surface of the keyboard 105 according to an embodiment of the present invention. The infrared-light touch sensing system includes an infrared light emitter 202 and an infrared light receiver 208. The infrared light travels above the surface of the keyboard 105 from the infrared light emitter 202 to the infrared light receiver 208. Two fingers 124(1 and 2) or any other object touching the surface of the keyboard 105 block the infrared light from being received by the infrared light receiver 208. As a result, the touches by the finger 124(1 and 2) can be detected.

Referring back to FIG. 1, the infrared light emitter 202 can be positioned along one edge of the keyboard 105 and the infrared light receiver 208 can be positioned along the opposite edge of the keyboard 105. In order to obtain coordinates of a touch, two sets of the infrared light touch sensors will be needed with one set positioned on the horizontal edges and the other on the vertical edges.

Although an infrared-light touch sensing system is described hereinbefore, other touch sensing systems, such as the one using a video camera or ultrasound can also be used.

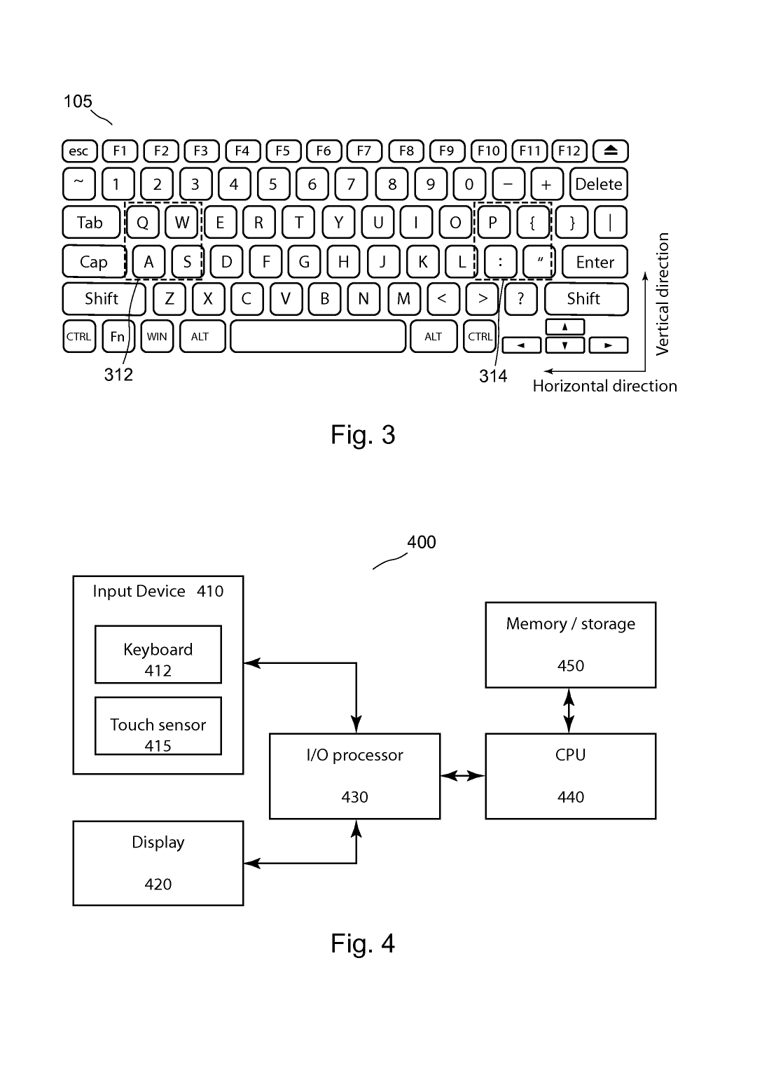

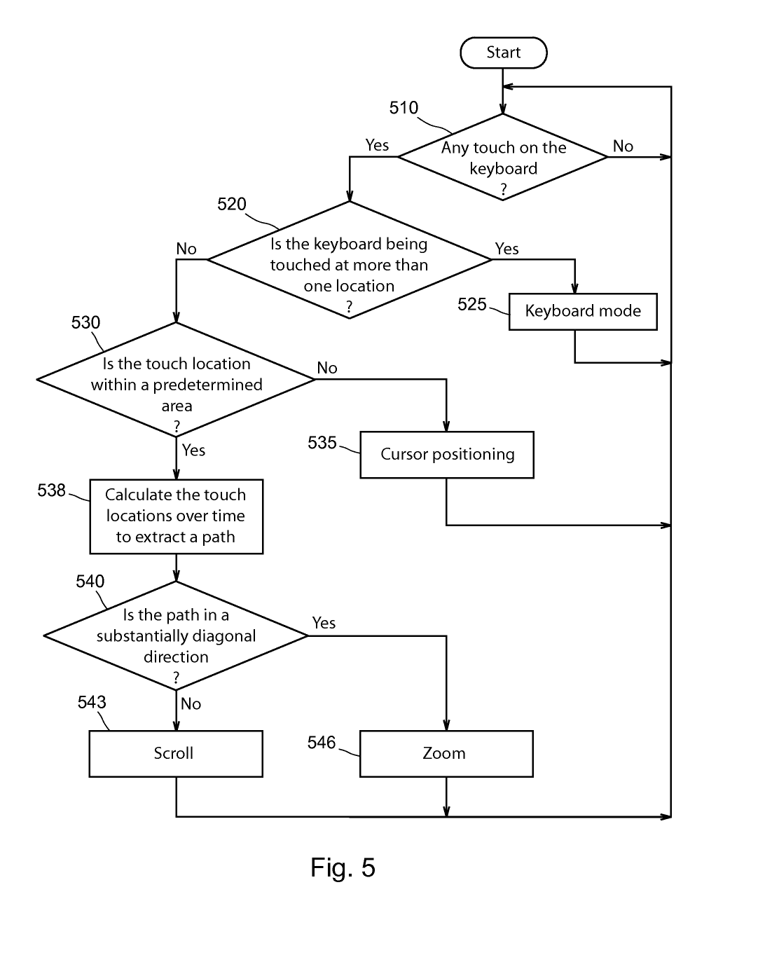

FIG. 3 is a layout diagram of keys of the keyboard 105 according to the embodiment of the present invention. There are two touch sensing regions 312 and 314, one in the left side and the other in the right side the keyboard that are designated by a keyboard-mouse combo (KMC) software for detecting scrolling and zooming operations. The designated regions 312 and 314 are within a larger touch sensing area which substantially covers the entire key area of the keyboard 105. The designated touch sensing regions 312 and 314 can be marked out on the surface of the keyboard 105, so that a computer user can clearly identify boundaries thereof. The function of the designated touch sensing regions 312 and 314 will be depicted in FIG. 5 and associated descriptions hereinafter.

FIG. 4 is a block diagram of a computing system 400 with a KMC device according to the embodiment of present invention. The computing system 400 includes an input device 410, a display 420, an input/output (I/O) processor 430, a central processing unit (CPU) 440 and a memory and storage unit 450. The input device 410 comprises a keyboard 412 and a touch sensor 415 which overlays the keyboard 410 as described in FIGS. 1-3. The keyboard 412 and the touch sensor 415 form the KMC device. The I/O processor 430 is the hardware that executes the KMC software.

FIG. 5 is a flow chart diagram illustrating steps of certain operations of the KMC device according to the embodiment of the present invention. The keyboard-mouse operation starts with the touch sensor 415 detecting if there is any object touching the surface of the keyboard 412 in step 510 while the touched key(s) are not pressed. In case the keyboard 412 is not touched, the KMC device keeps detecting. In case the keyboard 412 is touched, then the KMC device will detect the number of locations the keyboard 412 is touched in step 520. If the keyboard 412 is simultaneously touched at more than one location, the KMC device will enter into a keyboard mode operation in step 525, in which the KMC device interprets a key press as a conventional keyboard entry of a character, and ignores any particular touch or movement of a touch location.

Referring again to FIG. 5, if the keyboard 412 is touched at only one location at a time while the touched key are not pressed, the KMC device will then detect if that one touch location is within the designated touch sensing regions 312 and 314 in step 530. If the touch location is outside the designated touch sensing regions 312 and 314, the KMC device then interprets the touch as a cursor positioning operation in step 535, in which the cursor moves in response to a movement of the touch location. The cursor positioning operation 535 is equivalent to moving a conventional mouse. If the touch location is within the designated touch sensing regions 312 and 314 while the touched key is not pressed, the KMC device will calculate a change of the touch location over time to extract a path in step 538. Then a direction of the path is detected in step 540. If the touch location draws a substantially diagonal path, the KMC device will interpret the touch location movement as a zoom operation in step 546. The zoom operation can be either a zoom-in or a zoom-out operation. As an example, the zoom-in operation can be in response to a touch location path starting from a lower left corner and ending at the upper right corner of the designated touch sensing region 314; and the zoom-out operation is in response to a touch location path starting from a upper left corner and ending at the lower right corner of the designated touch sensing region 314. If the touch location does not draw a substantially diagonal path, the KMC device will interpret the touch location movement as a scroll operation in step 543. If the touch location path is substantially horizontal, i.e., in a left-and-right direction, then the touch movement will be interpreted as a horizontal scroll. If the touch location path is substantially vertical, i.e., in an up-and-down direction, then the touch movement will be interpreted as a vertical scroll.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A computer input method comprising:
detecting key press by a keyboard having a plurality of permanent keys for entering commands and characters into the computer, a surface area of the plurality of permanent keys having a designated region;
detecting touch on the surface area of the plurality of permanent keys;
entering into a cursor positioning mode when only one first touch on the surface of the plurality of permanent keys being detected while the key touched by the first touch not being pressed and the first touch being located outside the designated region; and
entering into a scroll-and-zoom mode when only one second touch on the surface of the plurality of permanent keys being detected while the key touched by the second touch not being pressed and the second touch being located inside the designated region and in a move.

2. The computer input method of claim 1, wherein the plurality of permanent keys is tactile key.

3. The computer input method of claim 1 further comprising entering into a keyboard mode when two or more simultaneously touched locations on the surface area of the plurality of permanent keys being detected.

4. The computer input method of claim 1 further comprising obtaining a path of the touch location movement while in the scroll-and-zoom operation.

5. The computer input method of claim 4 further comprising entering into a scrolling operation when the path is substantially in a horizontal or a vertical direction.

6. The computer input method of claim 4 further comprising entering into a zooming operation when the path is substantially in a diagonal direction.

7. A computer input method comprising:
detecting key press by a keyboard having a plurality of permanent keys for entering commands and characters into the computer, a surface area of the plurality of permanent keys having a designated region;
detecting touch on the surface area of the plurality of permanent keys;
entering into a cursor positioning mode when only one first touch on the surface of the plurality of permanent keys being detected while the key touched by the first touch not being pressed and the first touch being located outside the designated region;
entering into a scroll-and-zoom mode when only one second touch on the surface of the plurality of permanent keys being detected while the key touched by the second touch not being pressed and the second touch being located inside the designated region and in a move; and
entering into a keyboard mode when two or more simultaneously touched locations on the surface area of the plurality of permanent keys being detected.

8. The computer input method of claim 7, wherein the plurality of permanent keys is tactile key.

9. The computer input method of claim 7 further comprising obtaining a path of the touch location movement while in the scroll-and-zoom operation.

10. The computer input method of claim 9 further comprising entering into a scrolling operation when the path is substantially in a horizontal or a vertical direction.

11. The computer input method of claim 9 further comprising entering into a zooming operation when the path is substantially in a diagonal direction.

12. A computer input device comprising:
a keyboard having a plurality of permanent keys for entering commands and characters into the computer, a surface area of the plurality of permanent keys having a designated region; and
a touch senor for detecting one or more touches on the surface area of the plurality of permanent keys by one or more objects,
wherein the computer input device is configured to enter into a cursor positioning mode when the touch senor has detected only one first touch on the surface of the plurality of permanent keys while the key touched by the first touch is not being pressed and the first touch is located outside the designated region, and the computer input device is configured to enter into a scroll-and-zoom mode when the touch senor has detected only one second touch on the surface of the plurality of permanent keys while the key touched by the second touch is not being pressed and the second touch is located inside the designated region and in a move.

13. The computer input device of claim 12, wherein the plurality of permanent keys are tactile keys.

14. The computer input device of claim 12, wherein the touch sensor has an optical emitter and an optical receiver.

15. The computer input device of claim 12, wherein the computer input device is configured to enter into a keyboard mode when the touch sensor has detected two or more locations on the surface area of the plurality of permanent keys being simultaneously touched.

16. The computer input device of claim 15, wherein the computer input device is configured to ignore any movement of the touch location in the keyboard mode.

17. The computer input device of claim 12, wherein the computer input device is configured to obtain a path of the touch location movement when the computer input device is in the scroll-and-zoom mode.

18. The computer input device of claim 17, wherein the computer input device is configured to enter into a scrolling operation when the path is substantially in a horizontal or a vertical direction.

19. The computer input device of claim 17, wherein the computer input device is configured to enter into a zooming operation when the path is substantially in a diagonal direction.
